(19) United States
(12) Patent Application Publication
(10) Pub. No.: US 2013/0038188 A1
(43) Pub. Date: Feb. 14, 2013

(54) MULTI-FUNCTION PRINTER

(71) Applicant: Ching-Feng Lin, New Taipei City (TW)

(72) Inventor: Ching-Feng Lin, New Taipei City (TW)

(73) Assignees: Kinpo Electronics, Inc., New Taipei City (TW); Cal-Comp Electronics & Communications Company Limited, New Taipei City (TW)

(21) Appl. No.: 13/227,478

(22) Filed: Sep. 8, 2011

(30) Foreign Application Priority Data
Aug. 10, 2011 (TW) 100128557

(51) Int. Cl. B41J 29/02

(52) U.S. Cl. 312/319.2; 312/326

(57) ABSTRACT

A multi-function printer including a body, a door, a carriage, and a linkage is provided. The door is assembled to the body and capable of being opened or closed relative to the body. The carriage is movably disposed on the body. The linkage disposed in the body is configured between the carriage and the door. The linkage has a driven end and a driving end. The driven end is located on a moving path of the carriage, and the door is located on a moving path of the driving end. When the carriage moves to a pushing segment, the carriage drives the driven end of the linkage, such that the driving end of the linkage pushes the door open.

### CROSS-REFERENCE TO RELATED APPLICATION

This application claims the priority benefit of Taiwan application serial no. 100128557, filed on Aug. 10, 2011. The entirety of the above-mentioned patent application is hereby incorporated by reference herein and made a part of this specification.

### BACKGROUND OF THE INVENTION

1. Field of the Invention

The present invention relates to a door opening structure, and more particularly, to the door opening structure of a multi-function printer.

2. Description of Related Art

As the information society arrives, office automatic equipments such as scanners, photocopiers or printers are disposed in offices, and users may perform secretarial processing operations using these office automatic equipments. It should be noted that when the above plurality of office automatic equipments are simultaneously disposed in the office, a lot of space is consumed. As a result, a multi-function peripheral (MFP) integrated with functions such as copying, printing, and scanning is developed to resolve the above problem.

Furthermore, the present information technology has gradually become a gradation of cloud computing which improves the information processing speed and the convenience in operation. Cloud computing is a technology by which the ultra-high speed operation and extra-large storage of a server group are utilized through the Internet so that it is unnecessary to run software installed on personal computers or store data into local hard disk. And accordingly, various operations can be carried out and files and data can be stored over the Internet, i.e., the enormous virtual space. In other words, relative operation of the multi-function printer can be controlled without any restrictions of time or place.

### SUMMARY OF THE INVENTION

The present invention provides a multi-function printer having an auto door opening structure.

A multi-function printer including a body, a door, a carriage and a linkage is provided in an embodiment of the present invention. The door is assembled to the body and capable of being opened or closed. The carriage is disposed in the body and capable of moving back and forth in the body. The linkage is disposed in the body and located between the carriage and the door. The linkage has a driven end and a driving end, wherein the driven end is located on a moving path of the carriage, and the door is located on a moving path of the driving end. When the carriage moves to a pushing segment, the carriage drives the driven end of the linkage so that the driving end pushes the door to be opened relative to the body.

In an embodiment of the present invention, the moving path of the carriage further includes a printing segment. The pushing segment is located beside the printing segment and not overlapping with the printing segment.

In an embodiment of the present invention, the printing segment is located at a central region of the moving path of the carriage. The pushing segment is located at an end of the moving path of the carriage.

In an embodiment of the present invention, the door is pivoted to the body and suitable for rotating along a shaft so as to be opened or closed relative to the body. And the shaft is parallel to the moving path of the carriage.

In an embodiment of the present invention, the linkage includes a first link member and a second link member. The first link member is pivoted to the body and has the driven end. The second link member is movably assembled to the body and pivoted to the first link member. The driving end is located at an end of the second link member relative distant from the first link member.

In an embodiment of the present invention, the second link member has a sliding slot and the body has a guiding pin. The guiding pin is coupled into the sliding slot so that the second link member slides relative to the body, or the second link member simultaneously slides and rotates relative to the body.

In an embodiment of the present invention, the linkage includes a torsion spring connected between the first link member and the body.

In light of the above, in the embodiment of the multi-function printer of the present invention, since the linkage is configured between the carriage and the door, the linkage is driven to push the door to be opened relative to the body when the carriage is driven to the pushing segment. Such function enables the door to open automatically by the motion of the carriage without manual operation, and the multi-function printer further complies with the required function of the cloud computing equipment.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 and FIG. 2 are schematic views respectively illustrating a multi-function printer under two different conditions according to an embodiment of the present invention.

FIG. 3 and FIG. 4 are schematic top views of the multi-function printer of FIG. 1 and FIG. 2 respectively.

### DESCRIPTION OF EMBODIMENTS

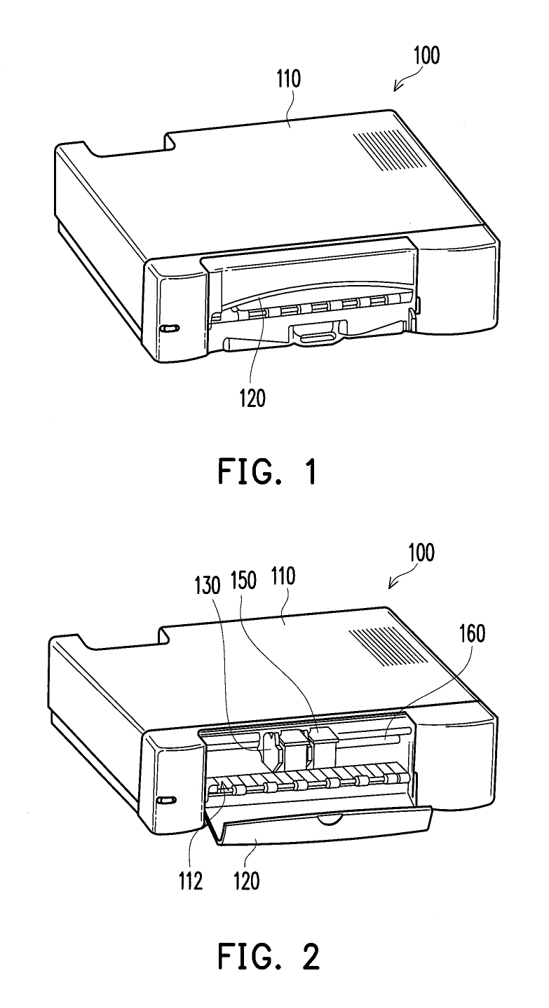

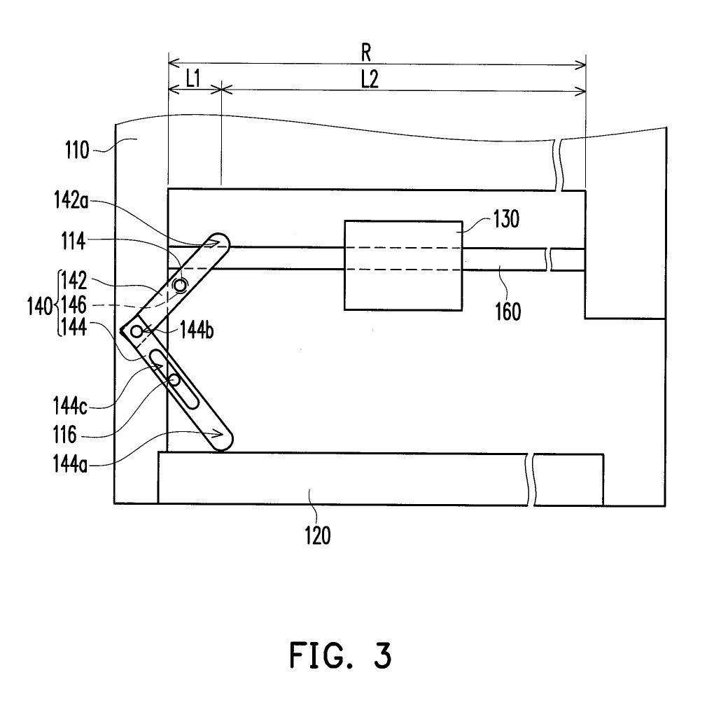

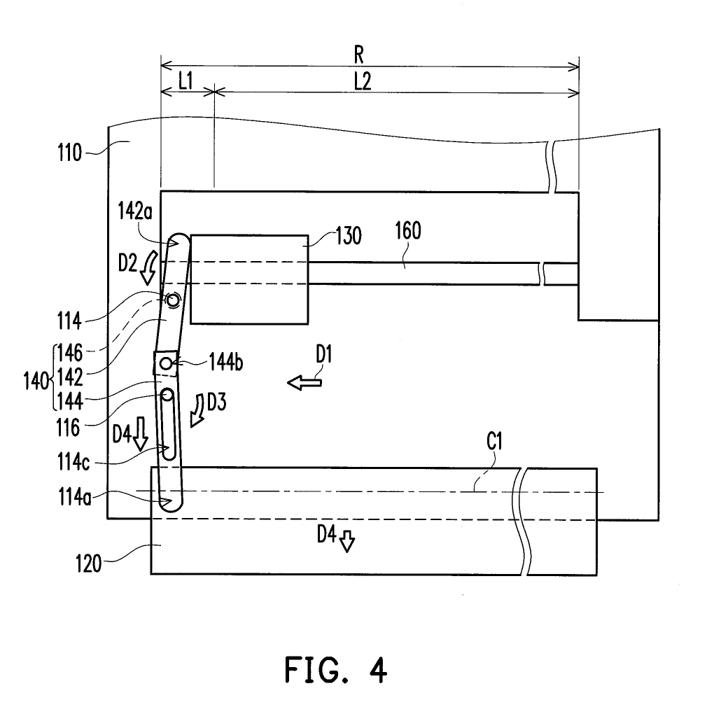

FIG. 1 and FIG. 2 are schematic views respectively illustrating a multi-function printer under two different conditions according to an embodiment of the present invention. FIG. 3 and FIG. 4 are schematic top views of the multi-function printer of FIG. 1 and FIG. 2 respectively. And only the essential components are illustrated in FIG. 3 and FIG. 4 in order to clearly show the correlations between the components. Referring to FIG. 1 to FIG. 4, the multi-function printer 100 includes a body 110, a door 120, a carriage 130 and a linkage 140 in the present embodiment. The body 110 has a paper outlet 112. The door 120 is pivoted to the body 110 and capable of rotating along a shaft C1 relative to the body 110 and to be open or close the paper outlet 112. Herein the printed or scanned paper (not shown) is passed through the paper outlet 112 from the body 110 and transmitted out from the multi-function printer 100, in the condition that the door 120 is opened relative to the body 110 (as shown in FIG. 2).

The carriage 130 is assembled in the body 110 and the ink cartridge 150 and the inkjet printhead (not shown) are disposed on the carriage 130. The carriage 130 is connected to a transmitting mechanism 160. The carriage 130 is driven by the transmitting mechanism 160 and moves back and forth along a moving path R. Thus, the inkjet printhead disposed upon the carriage 130 is indirectly driven by the transmitting mechanism 160 to move and executes the inkjet printing operations. However, the form of the carriage 130 is not limited thereby, and in another embodiment not shown in the figures, an image extracting module can also be disposed on the carriage so that the carriage can similarly move and execute the image scanning operations by using the transmitting mechanism 160.

Referring to FIG. 3 and FIG. 4, it has to be noted that the linkage 140 is disposed in the body 110 and located between the carriage 130 and the door 120. The linkage 140 includes a first link member 142 and a second link member 144 which are connecting to each other, wherein the first link member 142 is assembled to a pivot axle 114 which is on the body 110. And the first link member 142 has a driven end 142a which is located on the moving path R of the carriage 130. In addition, the second link member 144 has a driving end 144a and a pivoting end 144b opposing to the driving end 144a, wherein the pivoting end 144b is pivoted to an end of the first link member 142 distant from the driven end 142a. And the driving end 144a is located at the end of the second link member 144 distant from the first link member 142. And the door 120 is located on a moving path of the driving end 144a.

Accordingly, when the carriage 130 moves to a pushing segment L1 of the moving path R through the transmitting mechanism 160, the carriage 130 props against the driven end 142a of the first link member 142 to rotate the first link member 142. Then, the first link member 142 drives the driving end 144a of the second link member 144 to push the door 120, and then the door 120 rotates and opens relative to the body 110.

To be more specific, the moving path R of the carriage 130 includes a printing segment L2 and the pushing segment L1 not overlapping to each other. That is, regardless of the carriage 130 used in the scanning function or the printing function of the multi-function printer 100, the moving path R can be classified into the operating area which is located at the central area and the non-operating area located at the rest of the moving path R. For example, in the present embodiment, the moving area the printing process is defined as the pushing segment L1 when the carriage 130 does not operate. When the carriage 130 does not operate the printing (or scanning) process, since the carriage 130 moves to the pushing segment L1 such that the linkage 140 can be driven, so as to proceed the printing process and push the door 120 to open and further avoiding the interfering when printing.

In addition, in the present embodiment, the second link member 144 further has a sliding slot 144c. And the body 110 further has a guiding pin 116. Through the guiding pin 116 coupling to the sliding slot 144c, the second link member 144 can simultaneously slide and rotate relative to the body 110. For instance, when the carriage 130 moves along the first direction D1 and pushes the pushing segment L1, the carriage 130 drives the first link member 142 to rotate along the second direction D2, and the first link member 142 further drives the second link member 144 to rotate along the third direction D3 and slide along the fourth direction D4, and finally the door 120 leaves the paper outlet 112 (D4 illustrates the tangential direction when it rotates). Then, the moving path R of the carriage 130 is parallel to the shaft C1 of the door 120. In other words, through the mechanical feature of the linkage 140 of the present embodiment, the movement of the carriage 130 can further be applied into the action of the door 120 opened or closed relative to the body 110. However, the kinds of motions between the link members 142, 144 are not limited in the present invention. The designer can appropriately design the linkage 140 according to the required internal space of the body 110 and manufacturing cost.

On the other hand, referring to FIG. 3 and FIG. 4, in the present embodiment, in order to make the first link member 142 and the second link member 144 enable to return to the state of FIG. 3 from the state of having been pushed as shown in FIG. 4, the linkage 140 further includes a torsion spring 146 connected between the first link member 142 and the body 110. When the carriage 130 drives the first link member 142 to rotate, it also exerts force to the torsion spring 146. Thus, after the door 120 is opened and the carriage 130 leaves the pushing segment L1, then the elastic force of the torsion spring 146 drives the first link member 142 (also drives the second link member 144) to return to the original state illustrated in FIG. 3.

In light of the foregoing, in the embodiment of the multi-function printer of the present invention, since the linkage is configured between the carriage and the door, the linkage is driven to push the door to be opened relative to the body when the carriage is driven to the pushing segment. Such function enables the door of the multi-function printer to be open by the motion of the carriage without manual operation. Thus, the multi-function printer can further comply with the required function of the cloud computing equipment.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A multi-function printer, comprising:
a body;
a door assembled to the body and capable of being opened or closed;
a carriage disposed in the body and capable of moving back and forth in the body; and
a linkage disposed in the body and located between the carriage and the door, the linkage having a driven end and a driving end, wherein the driven end is located on a moving path of the carriage, and the door is located on a moving path of the driving end, when the carriage moves to a pushing segment, the carriage drives the driven end of the linkage such that the driving end pushes the door to be opened relative to the body.

2. The multi-function printer as claimed in claim 1, wherein the moving path of the carriage further comprises a printing segment, the pushing segment is located beside the printing segment and not overlapping with the printing segment.

3. The multi-function printer as claimed in claim 2, wherein the printing segment is located at a central region of the moving path of the carriage, the pushing segment is located at an end of the moving path of the carriage.

4. The multi-function printer as claimed in claim 1, wherein the door is pivoted to the body and suitable for rotating along a shaft so as to be opened or closed relative to the body, and the shaft is parallel to the moving path of the carriage.

5. The multi-function printer as claimed in claim 1, wherein the linkage comprises:
a first link member pivoted to the body and having the driven end; and
a second link member movably assembled to the body and pivoted to the first link member, and the driving end is located at an end of the second link member relatively distant from the first link member.

6. The multi-function printer as claimed in claim 5, wherein the second link member has a sliding slot, and the body has a guiding pin, the guiding pin is coupled into the sliding slot so that the second link member slides relative to the body, or the second link member simultaneously slides and rotates relative to the body.

7. The multi-function printer as claimed in claim 5, wherein the linkage further comprises:
a torsion spring connected between the first link member and the body.
